(19) United States
(12) Patent Application Publication
(10) Pub. No.: US 2016/0298995 A1
(43) Pub. Date: Oct. 13, 2016

(54) SYSTEMS AND METHODS FOR MONITORING LIQUID LEVELS IN CONTAINERS ON HEATING ASSEMBLIES

(71) Applicant: General Electric Company, Schenectady, NY (US)

(72) Inventor: An Eun Yeong, Seoul (KR)

(21) Appl. No.: 14/684,488

(22) Filed: Apr. 13, 2015

(51) Int. Cl. G01F 23/24

(52) U.S. Cl. CPC G01F 23/246

(57) ABSTRACT

Systems and methods for monitoring a liquid level within an interior of a container positioned on a heating assembly are provided. A method includes calculating a temperature change within the interior of the container during a predetermined time period, and determining whether a heating element of the heating assembly is on. The method further includes outputting an error signal to an indicator when the temperature change is negative and the heating element is on.

### FIELD OF THE INVENTION

The present disclosure relates generally to heating assemblies, such as cooktops, oven appliances, and stand-alone heat plates and burners. In particular, the present disclosure is directed to systems and methods for monitoring the liquid level within the interior of a container positioned on a heating assembly.

### BACKGROUND OF THE INVENTION

Heating assemblies are frequently utilized in a variety of settings to cook food items. In particular, heating assemblies are utilized to heat water or other liquids held in containers that are positioned on the food items. Cooktops, which may be utilized alone or built in to oven appliances, frequently include a plurality of burner assemblies on which such containers can be positioned. A heating element of the heating assembly is then turned on to heat the liquid within the container.

One concern during such operation of heating assemblies is the level of the liquid within the container. Liquid may for example evaporate during heating operations, resulting in a drop in the level of liquid in the container. In some cases this can result in insufficient liquid for cooking purposes. In other cases this can result in the absence of liquid from the container, which can then cause damage to the container by continued heating thereof.

In some cases, mechanical floats or capacitive proximity sensors have been utilized to measure the existence and level of liquid in containers during heating operations. However, such known approaches either utilize components which are not reliable at high liquid temperatures or which are generally expensive.

Accordingly, improved systems and methods for monitoring liquid levels within the interiors of containers positioned on heating assemblies are desired. In particular, systems and methods which provide reliable performance and are cost-effective would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, a method for monitoring a liquid level within an interior of a container positioned on a heating assembly is provided. The method includes calculating a temperature change within the interior of the container during a predetermined time period, and determining whether a heating element of the heating assembly is on. The method further includes outputting an error signal to an indicator when the temperature change is negative and the heating element is on.

In accordance with another embodiment, a system for monitoring a liquid level within an interior of a container positioned on a heating assembly is provided. A system includes a temperature sensor positionable within the interior of the container, and a controller in communication with the temperature sensor and a heating element of the heating assembly. The controller is operable for calculating a temperature change within the interior of the container during a predetermined time period, and determining whether a heating element of the heating assembly is on. The controller is further operable for outputting an error signal when the temperature change is negative and the heating element is on.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an oven appliance according to an exemplary embodiment of the present subject matter.

FIG. 2 provides a section view of the oven appliance of FIG. 1 taken along the 2-2 line of FIG. 1.

FIG. 3 provides a perspective view of an exemplary embodiment of cooktop according to an exemplary embodiment of the present subject matter.

FIG. 4 provides a schematic cross-sectional view of a system for monitoring a liquid level within the interior of a container positioned on a heating assembly in accordance with one embodiment of the present disclosure; and

FIG. 5 is a flow chart illustrating a method for monitoring a liquid level within the interior of a container positioned on a heating assembly in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

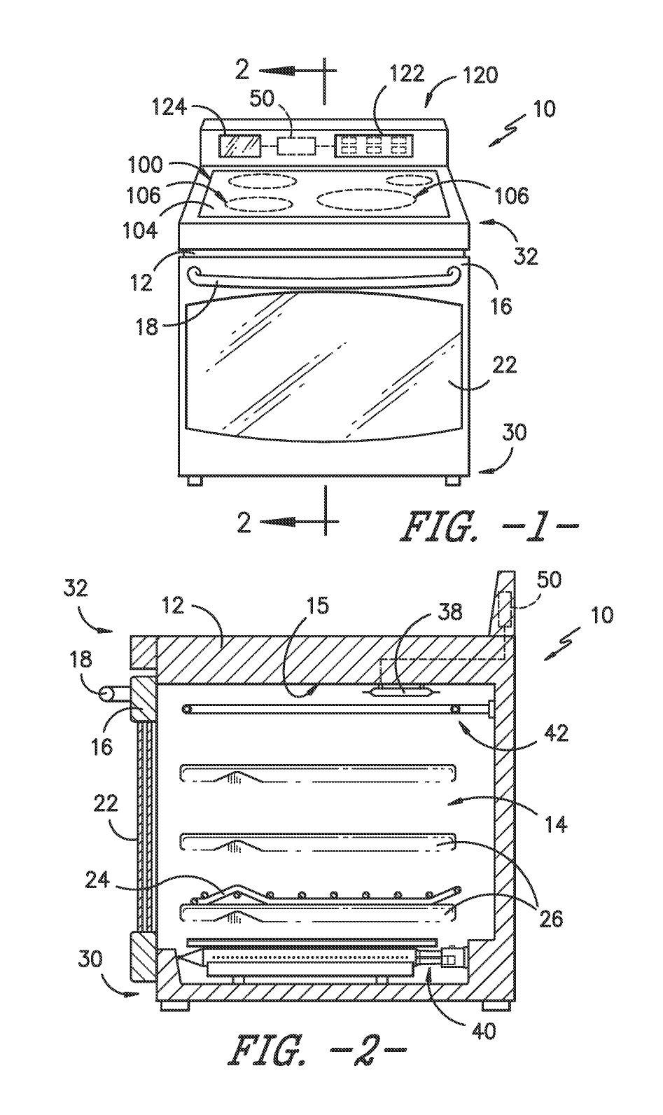

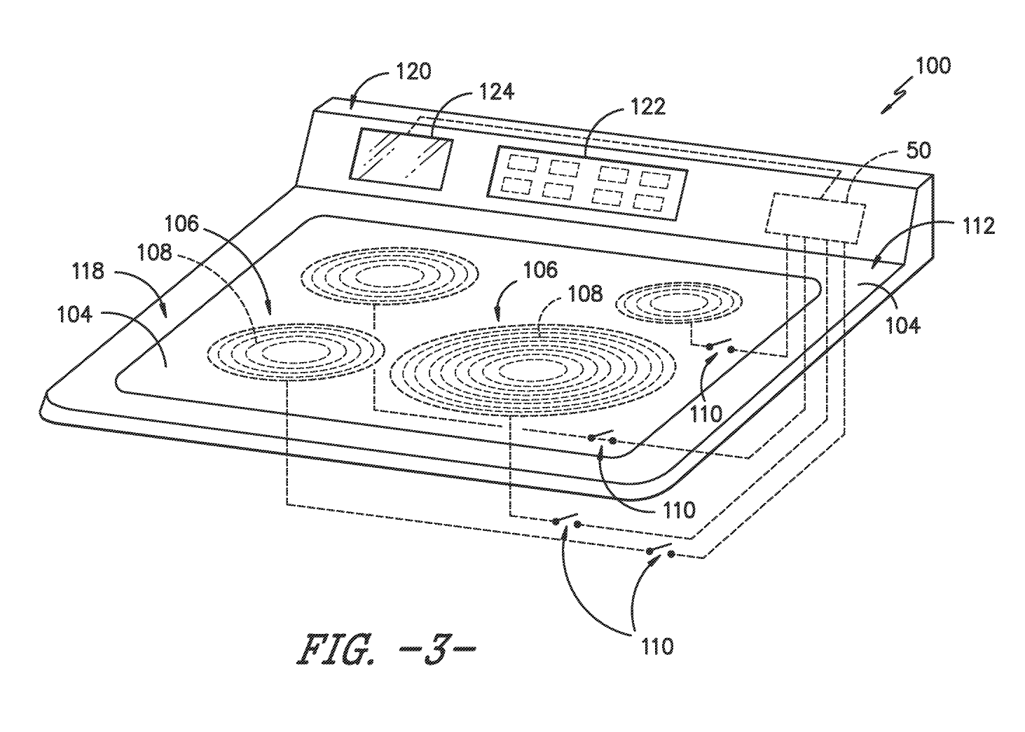

FIG. 1 provides a perspective view of an oven appliance 10 according to an exemplary embodiment of the present subject matter. FIG. 2 provides a section view of oven appliance 10 taken along the 2-2 line of FIG. 1. Oven appliance 10 is provided by way of example only and is not intended to limit the present subject matter in any aspect. Thus, the present subject matter may be used with other oven appliance configurations, e.g., that define one or more interior cavities for the receipt of food and/or having different pan or rack arrangements than what is shown in FIG. 2. Further, the present subject matter may be used in any other suitable appliance.

Oven appliance 10 generally includes an insulated cabinet 12 with an interior cooking chamber 14 defined by an interior surface 15 of cabinet 12. Cooking chamber 14 is configured for the receipt of one or more food items to be cooked. Oven appliance 10 includes a door 16 rotatably mounted to cabinet 12, e.g., with a hinge (not shown). A handle 18 is mounted to door 16 and assists a user with opening and closing door 16 in order to access cooking chamber 14. For example, a user can pull on handle 18 to open or close door 16 and access cooking chamber 14.

Oven appliance 10 can include a seal (not shown) between door 16 and cabinet 12 that assist with maintaining heat and cooking fumes within cooking chamber 14 when door 16 is closed as shown in FIG. 2. Multiple parallel glass panes 22 provide for viewing the contents of cooking chamber 14 when door 16 is closed and assist with insulating cooking chamber 14. A baking rack 24 is positioned in cooking chamber 14 for the receipt of food items or utensils containing food items. Baking rack 24 is slidably received onto embossed ribs or sliding rails 26 such that rack 24 may be conveniently moved into and out of cooking chamber 14 when door 16 is open.

A gas fueled or electric bottom heating element 40 (e.g., a gas burner or a bake gas burner) is positioned in cabinet 12, e.g., at a bottom portion 30 of cabinet 12. Bottom heating element 40 is used to heat cooking chamber 14 for both cooking and cleaning of oven appliance 10. The size and heat output of bottom heating element 40 can be selected based on the e.g., the size of oven appliance 10.

A top heating element 42 is also positioned in cooking chamber 14 of cabinet 12, e.g., at a top portion 32 of cabinet 12. Top heating element 42 is used to heat cooking chamber 14 for both cooking/broiling and cleaning of oven appliance 10. Like bottom heating element 40, the size and heat output of top heating element 42 can be selected based on the e.g., the size of oven appliance 10. In the exemplary embodiment shown in FIG. 2, top heating element 42 is shown as an electric resistance heating element. However, in alternative embodiments, a gas, microwave, halogen, or any other suitable heating element may be used instead of electric resistance heating element 42.

The operation of oven appliance 10 including heating elements 40 and 42 is controlled by a processing device such as a controller 50, which may include a microprocessor or other device that is in communication with such components. Such controller 50 may also be communication with a temperature sensor 38 that is used to measure temperatures inside cooking chamber 14 and provide such measurements to the controller 50. Temperature sensor 38 is shown (in FIG. 2) in the top and rear of cooking chamber 14. However, other locations may be used and, if desired, multiple temperature sensors may be applied as well.

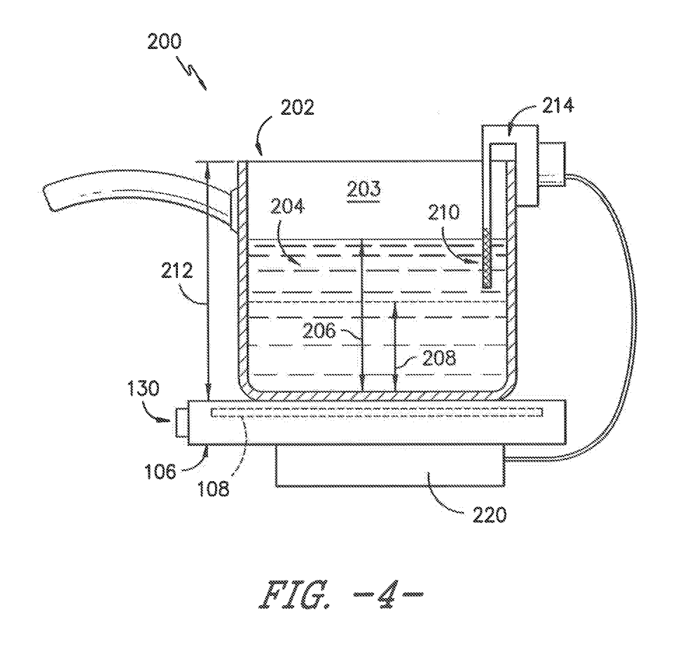

Referring now to FIGS. 1 and 3, a cooktop 100 is illustrated. Cooktop 100 may be included in oven appliance 10, as illustrated in FIG. 1, or may be a separate appliance from oven appliance 10. For example, in the embodiment of FIG. 1, cooktop 100 may be disposed on the cabinet 12. As show, cooktop 100 may include a top panel 104. By way of example, top panel 104 may be constructed of glass, ceramics, enameled steel, and combinations thereof. Heating assemblies 106, which in this embodiment are electric heating assemblies but in alternative embodiments may be gas burners or induction assemblies, may be mounted, for example, below the top panel 104. While shown with four heating assemblies 106 in the exemplary embodiment of FIG. 3 (as well as FIG. 1), cooktop appliance 100 may include any number of heating assemblies 106 in alternative exemplary embodiments. Heating assemblies 106 can also have various diameters. For example, each heating assembly of heating assemblies 106 can have a different diameter, the same diameter, or any suitable combination thereof. Each heating assembly may include one or more heating elements 108. Further, a relay 110 may be coupled to each heating element 108. Relays 110 can selectively activate the associated heating elements 108 as desired. Activation of a heating element 108 can cause electricity to be flowed to that heating element 108, which in turn can cause the heating element 108 to generate heat. This heat may be transferred through the top panel 104 to utensils positioned on the top panel 104. The operation of heating elements 108, such as through operation of relays 110, may be controlled by a processing device such as controller 50.

Referring to FIGS. 1 through 3, oven appliance 10 and/or cooktop 100 may further include a user interface panel 120. User interface panel 120 is generally a component that allows a user to interact with the oven appliance 10 to, for example, turn various heating elements (such as heating elements 40, 42, 108) on and off, adjust the temperature of the heating elements, set built-in timers, etc. A user interface panel 120 may include a touchscreen 122 and a graphical display 124, which may be separate from or a part of the touchscreen 122. The touchscreen 122, as discussed herein, may be utilized by a user to interact with the oven appliance 10 by touching the touchscreen 122 directly with, for example, a finger. Various commands for a user to select through such touching may be displayed by touchscreen 122, and detection of the user selecting a specific command by touching a distinct location on the touchscreen 122 may be detected by the controller 50, which is in communication with the touchscreen 122, based on electrical signals from the touchscreen 122. Graphical display 124 may generally deliver certain information to the user, which may be based on user selections and interaction with the touchscreen 122, such as whether a particular heating element is activated and/or the level at which the heating element is set.

Notably, controller 50 may be in communication with the touchscreen 122, graphical display 124, and one or more heating elements. Accordingly, input signals received from the touchscreen 122 may be provided to and interpreted by the controller 50, and the controller 50 may output corresponding control signals to the heating elements to operate the heating elements as desired.

Controller 50 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 50 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. User interface panel 120 and other components of oven appliance 10 may be in communication with controller 50 via one or more signal lines or shared communication busses.

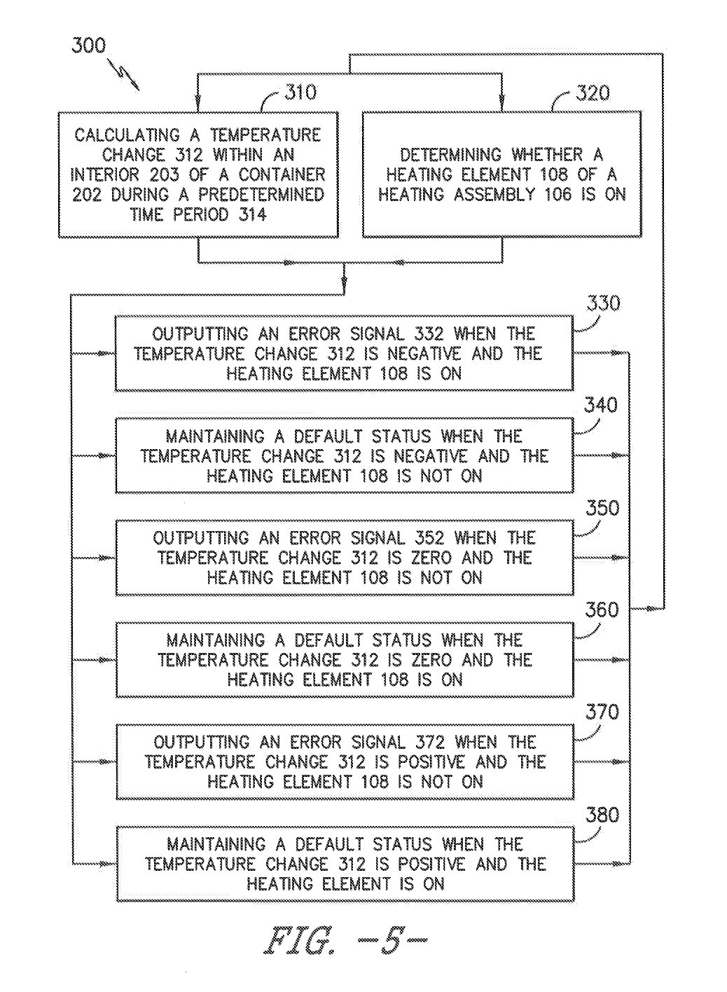

Referring now to FIG. 4, one embodiment of a system 200 for monitoring a liquid level within the interior of a container positioned on a heating assembly 106 is provided. As discussed, heating assembly 106 may include one or more heating elements 108. Each heating element 108 may be, for example, an electric heating element (such as an electrical coil), gas-based heating element (such as a gas burner), induction heating element, or other suitable element which generates heat when turned on. Heating assembly 106 may be a stand-alone heating assembly 106, such as an individual heat plate, burner, etc., or may be part of a cooktop 100 and/or oven appliance 10.

As shown, a container 202 may be positioned on a heating assembly 106. The container 202 may, for example, be a pot, pan, or other suitable cooking vessel capable of containing a liquid 204, such as water. Liquid 204 is illustrated as being contained within the container 202. For illustrative purposes, two liquid levels are illustrated within container 202, a first liquid level 206 and a second liquid level 208 below the first liquid level 206.

As discussed, it is generally desirable to monitor the level of liquid within an interior 203 of the container 202. Accordingly, system 200 includes a temperature sensor 210 and a controller 220. In embodiments wherein the heating assembly 106 is part of a cooktop 100 and/or oven appliance 10, controller 220 may be controller 50 or a component thereof, or may be an independent controller operably connectable to controller 50. Alternatively, controller 220 may be an independent and independently operable controller.

Controller 220 may be in communication with the heating assembly 106 and heating elements 108 thereof, such that controller 220 can generally determine whether the heating elements 108 are on or off. When a heating element 108 is on, it is actively generating heat. When a heating element 108 is off, it is not actively generating heat. Controller 220 may further be in communication with the temperature sensor 210 such that it can calculate temperature changes based on temperature signals received from the temperature sensor 210.

Such communication may be via a suitable wired or wireless connection, as is generally understood. Further, in some embodiments, circuit boards or other suitable apparatus may be included in the system 200 for facilitating communication between the temperature sensor 210 and controller 220.

Temperature sensor 210 may be any suitable device for sensing a temperature of a surrounding environment. For example, thermometers, bimetal temperature sensors, thermistors, thermocouples, and other suitable mechanical and/or electrical temperature sensors are within the scope and spirit of the present disclosure.

Temperature sensor 210 may be positionable within the interior 203 of the container 202. In particular, the sensor 210 may be positionable in a generally stationary position within the interior 203, such that the location of the temperature sensor 210 along a height 212 of the container 202 remains generally constant. In some embodiments, a coupling mechanism such as a hanger 214 (as shown), clip, magnet, etc. may removably couple the temperature sensor 210 to the container 202. Accordingly, when coupled to the temperature sensor 210, the location of the temperature sensor 210 along the height 212 of the container 202 may remain generally constant.

System 200 may generally be utilized to monitor a liquid level within the interior 203 of the container 202 positioned on a heating assembly 106. In particular, system 200 may be utilized to determine whether the liquid in the interior 203 is at a sufficient level, such as for a particular cooking purpose, for a user's desired level, or for safety purposes. In particular, system 200 may utilize differences in measured variable when the temperature sensor is submerged in liquid versus not submerged in liquid to make such determinations. In general, a liquid level (along the height 212) wherein temperature sensor 210 is not in contact with the liquid, such as second liquid level 208 as shown, may be considered an insufficient liquid level, whereas a liquid level wherein temperature sensor 210 is in contact with the liquid, such as first liquid level 206 as shown, may be considered a sufficient liquid level.

Notably, in exemplary embodiments, a user may position the temperature sensor 210 at a particular location along the height 212 to customize the location of insufficient (and sufficient) liquid levels.

In general, temperature sensor 210 may measure temperatures within the interior 203 of a container 202. These temperatures may, for example, be communicated to controller 220, which may calculate temperature changes based on the temperatures over a predetermined time period. Controller 220 may further be in communication with the heating element(s) 108 to determine whether the heating elements 108 are on. The temperature change and status of the heating elements 108 may then be utilized to conclude whether the liquid level within the interior 203 is sufficient. In cases wherein it is determined that the liquid level is not sufficient, an error signal may be generated and output to, for example, an indicator 230 to alert a user of the insufficient liquid level.

Indicator 230 generally is operable to receive an error signal, such as from controller 220, and to output an audio, visual, or sensory display when the error signal is received. Indicator 230 may, for example, be a light (as illustrated in FIG. 4) that activates on when it receives an error signal and has a default status of off. Alternatively, indicator 230 may be a user interface panel 120 or component thereof, such as graphical display 124. In these embodiments, a message may be displayed when an error signal is received, and no message may be displayed when in a default status. In still other embodiments, indicator 230 may be any suitable audio, visual, or sensor apparatus that can provide an alert when an error signal is received.

Referring now to FIG. 5 as well as FIG. 4, the present disclosure may further be directed to methods 300 for monitoring liquid levels within the interior 203 of a container 202 positioned on a heating assembly 106. Controller 220 of system 200 may, in exemplary embodiments, be operable to perform the various steps of a method 300 in accordance with the present disclosure.

Method 300 may thus include, for example, the step 310 of calculating a temperature change 312 within the interior 203 of the container 202 during a predetermined time period 314. In exemplary embodiments, the predetermined time period may be greater than or equal to 30 seconds, such as greater than or equal to one minute, such as greater than or equal to two minutes, such as greater than or equal to 3 minutes, such as greater than or equal to five minutes. The temperature change 312 may be calculated based on temperatures measured by the temperature sensor 210 during the predetermined time period 314. For example, in one embodiment, a temperature change 312 is calculated as the difference between the temperature at the end of the predetermined time period 314 and the temperature at the beginning of the predetermined time period 314. In other embodiments, the direction of the slope of a line which is fit (using a suitable mathematical model) to a plurality of temperatures measured during the predetermined time period 314 is utilized.

Method 300 may further include, for example, the step 320 of determining whether a heating element 108 of the heating assembly 106 (on which the container 202 is positioned) is on, as discussed above, during the predetermined time period 314 (such as for the entire predetermined time period 314, a predetermined range within the predetermined time period 314, or at any time during the predetermined time period 314).

Method 300 may further include, for example, the step 330 of outputting an error signal 332 when the temperature change 312 is negative and the heating element 108 is on. Error signal 332, which may be a first error signal 332, may generally indicate that the liquid level is insufficient. The error signal 332 may, for example, be output to an indicator 230.

Method 300 may further include, for example, the step 340 of maintaining a default status, such as of the indicator 230, when the temperature change 312 is negative and the heating element 108 is not on. Such step 340 may be accomplished by, for example, not sending an error signal to an indicator 230 or sending a signal to turn off the indicator 230 after an error signal has been previously received by the indicator. Default status may generally indicate that the liquid level is sufficient.

Method 300 may further include, for example, the step 350 of outputting an error signal 352, which may be referred to as a second error signal 352, when the temperature change 312 is zero and the heating element 108 is not on. Second error signal 352 may generally indicate that the liquid level is insufficient. The error signal 352 may, for example, be output to an indicator 230, which may be the same indicator 230 to which error signal 332 is output or a different indicator 230. In some embodiments, first error signal 332 and second error signal 352 are like signals which thus cause the indicator 230 to produce the same output signal (i.e. light color, sound, text, etc). In other embodiments, the signals 332, 352 may be different signals.

Method 300 may further include, for example, the step 360 of maintaining a default status, such as of the indicator 230 to which error signal 352 may be output, when the temperature change 312 is zero and the heating element 108 is on.

Method 300 may further include, for example, the step 370 of outputting an error signal 372, which may be referred to as a third error signal 372, when the temperature change 312 is positive and the heating element 108 is not on. Third error signal 372 may generally indicate that the system 200 is malfunctioning, such as because the temperature sensor 310 is unstable or because of another issue with the temperature sensor 310 or another component of the system 200. The error signal 372 may, for example, be output to an indicator 230, which may be the same indicator 230 to which error signal 332 is output or a different indicator 230. In some embodiments, first error signal 332 and second error signal 352 are like signals which thus cause the indicator 230 to produce the same output signal (i.e. light color, sound, text, etc). In other embodiments, the signals 332, 352 may be different signals.

Method 300 may further include, for example, the step 380 of maintaining a default status, such as of the indicator 230 to which error signal 372 may be output, when the temperature change 312 is positive and the heating element 108 is on.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for monitoring a liquid level within an interior of a container positioned on a heating assembly, the method comprising:
calculating a temperature change within the interior of the container during a predetermined time period;
determining whether a heating element of the heating assembly is on; and
outputting an error signal to an indicator when the temperature change is negative and the heating element is on.

2. The method of claim 1, further comprising maintaining a default status of the indicator when the temperature change is negative and the heating element is not on.

3. The method of claim 1, wherein the error signal is a first error signal, and further comprising outputting a second error signal when the temperature change is zero and the heating element is not on.

4. The method of claim 3, wherein the first error signal and the second error signal are like signals.

5. The method of claim 3, wherein the second error signal is output to the indicator.

6. The method of claim 3, further comprising maintaining a default status when the temperature change is zero and the heating element is on.

7. The method of claim 1, wherein the error signal is a first error signal, and further comprising outputting a third error signal when the temperature change is positive and the heating element is not on.

8. The method of claim 7, wherein the third error signal is different from the first error signal.

9. The method of claim 7, wherein the third error signal is output to the indicator.

10. The method of claim 7, further comprising maintaining a default status when the temperature change is positive and the heating element is on.

11. The method of claim 1, wherein the predetermined time period is greater than or equal to 30 seconds.

12. A system for monitoring a liquid level within an interior of a container positioned on a heating assembly, system comprising:
a temperature sensor positionable within the interior of the container; and
a controller in communication with the temperature sensor and a heating element of the heating assembly, the controller operable for:
calculating a temperature change within the interior of the container during a predetermined time period;
determining whether a heating element of the heating assembly is on; and
outputting an error signal when the temperature change is negative and the heating element is on.

13. The system of claim 12, further comprising an indicator operable to receive the error signal from the controller.

14. The system of claim 12, wherein the controller is further operable for maintaining a default status when the temperature change is negative and the heating element is not on.

15. The system of claim 12, wherein the error signal is a first error signal, and wherein the controller is further operable for outputting a second error signal when the temperature change is zero and the heating element is not on.

16. The system of claim 15, wherein the first error signal and the second error signal are like signals.

17. The system of claim 15, wherein the controller is further operable for maintaining a default status when the temperature change is zero and the heating element is on.

18. The system of claim 12, wherein the error signal is a first error signal, and wherein the controller is further operable for outputting a third error signal when the temperature change is positive and the heating element is not on.

19. The system of claim 18, wherein the third error signal is different from the first error signal.

20. The system of claim 18, wherein the controller is further operable for maintaining a default status when the temperature change is positive and the heating element is on.
